(19) United States
(12) Patent Application Publication
(10) Pub. No.: US 2002/0053084 A1
(43) Pub. Date: May 2, 2002

(54) Customized electronic program guide

(76) Inventors: George D. Escobar, Purcellville, VA (US); Carlos A. Silva JR., Potomac, MD (US); Robert M. Cooper, Washington, DC (US)

Correspondence Address: W. KARL RENNER, Fish & Richardson P.C., 601 Thirteenth Street, N.W., Washington, DC, 20005, US

(21) Appl. No.: 09/982,981

(22) Filed: Oct. 22, 2001

(30) Foreign Application Priority Data
Jun. 29, 2001 (US) 09893428
Jun. 1, 2000 (US) 09584348
Apr. 9, 2001 (US) 09828469

(51) Int. Cl. G06F 3/00; H04N 5/445; G06F 13/00

(52) U.S. Cl. 725/47; 725/46; 725/39

(57) ABSTRACT

A method for creating an electronic program guide (EPG) is described. A viewer's input to a set top box is monitored. The monitored viewer's input is analyzed and the content for the EPG is customized based on the viewer's analyzed input. The viewer's input to the set top box can be stored in a viewer file and updated with additional viewer input. The viewer's input may include signals from a viewer input device, such as, for example, a remote control, a keypad, a keyboard, or a wireless keyboard. The viewer's input may be sent to a host. The host performs the monitoring, the analyzing, and the customizing. In addition, the viewer's input may be analyzed by the set top box or a combination of the set top box and the host. The viewer's input may include signals indicating a change of channels, a guide selection, a category selection, a programming selection, a recorded programming, a viewed web page, and a rating of show. The customized EPG may include an interactive link, a web page, a chat room, an advertisement, a program guide, a TV channel, a customized viewer interactive EPG interface, and one or more mini-guides.

This application claims priority from U.S. application Ser. No. 09/584,348, filed Jun. 1, 2000, and titled “Managing Electronic Content from Different Sources,” and U.S. application Ser. No. 09/828,469, filed, Apr. 9, 2001, and titled “Contextual Programming,” both of which are incorporated by reference.

### TECHNICAL FIELD

This invention relates generally to electronic program guides and in particular to selecting content for electronic program guides.

### BACKGROUND

As the number of channels has increased with the proliferation of cable and satellite television (TV), a viewer has access to an unprecedented variety of TV content. However, the considerable number of channels has made a viewer's selection of TV content more difficult. In response, TV content providers have created electronic program guides to aid a viewer's selection of TV content. An electronic program guide provides a viewer with a tool for locating TV content. An electronic program guide helps the viewer navigate each channel's TV content by displaying an overview of the programming available at any date and time. Using the electronic program guide a viewer can determine a date and time associated with particular TV content. In addition, the electronic program guide is displayed on a viewer's TV and requires minimal instruction to use. As a result, the electronic program guide has become a popular way for viewers to manage TV content selection.

### SUMMARY

In one general aspect, an electronic program guide (EPG) may be created based on a viewer's input to a set top box. The viewer's input is monitored and analyzed. The content for the EPG may be customized based on the viewer's analyzed input. The viewer's input to the set top box may be stored in a viewer file and updated with additional viewer input. The viewer's input may include signals from a viewer input device, such as, for example, a remote control, a keypad, a keyboard, or a wireless keyboard.

The viewer's input may be monitored by a host. The host may analyze the viewer's input and customize the EPG based on the viewer's input. The customized EPG may be sent to the viewer's set top box for display.

Implementations may include one or more the following features. For example, the set top box may include a memory that stores the viewer's input data. The viewer's input data may be sent periodically to a host for analysis. The EPG may be customized based on the analyzed viewer input data. The viewer's input data may include signals indicating, for example, a change of channels, a guide selection, a category selection, a programming selection, a recorded program, a viewed web page, and a rating of a show.

The customized content of the EPG may be transmitted from the host to the set top box. The set top box may display a customized EPG that includes the customized content. In particular, the customized content may be stored in a memory of the set top box, and the EPG may be created based on the stored customized content. The customized EPG may include, for example, an interactive link, a web page, a chat room, an advertisement, a program guide, a TV channel, and a customized, viewer-interactive EPG interface.

In another general aspect, a system for customizing content of an EPG may include a display device, a set top box connected to the display device, a communications link for exchanging data with the set top box, and a host. The host may connect to the set top box using the communications link. The host may receive data indicating the viewer's input to the set top box. The host also may monitor and analyze the viewer's input to create a customized EPG for display on the display.

The set top box may include a memory for storing the viewer's input data in a viewer file. The data from the viewer file may be periodically sent to the host for analysis. A customized EPG may be created based on the analyzed viewer file data. The customized EPG may be sent from the host to the set top box and displayed on a display device. The set top box may include a memory for storing data associated with a customized EPG. The stored data may be used to create the customized EPG. The customized EPG may include, for example, an interactive link, a web page, a chat room, an advertisement, a program guide, a TV channel, and a customized, viewer-interactive EPG interface.

The system also may include a viewer input device that generates signals to control the set top box. The signals may include, for example, a changing of channels, a selection of a guide, a selection of category, a selection of a program, a recording of programming, a selection of a web page, and a rating of a show.

In yet another general aspect, a set top box may include an interface for outputting display data, an input for receiving a viewer command, an interface for sending the viewer command to be analyzed, an interface for receiving EPG data, and a processor for creating a customized EPG display from the received EPG data for output to the display interface. The received EPG data may be based on the analyzed viewer command. In addition, the set top box may include a memory for storing the viewer command. The viewer command may include, for example, a change channels command, a guide selection command, a category selection command, a programming selection command, a record programming command, a web page selection command, a web link selection command, and a show rating command.

The set top box also may include a memory for storing data associated with a customized EPG. The processor may use the stored data to create the customized EPG or portions of the customized EPG. The customized EPG may include, for example, an interactive link, a web page, a chat room, an advertisement, a program guide, a TV channel, a customized, viewer-interactive EPG interface, and one or more mini-guides.

The analysis of the viewer's input also may be carried out by the processor of the set top box. Customization software may be stored on a storage device of the set top box and accessed by the processor to analyze viewer input. The viewer input data and customized EPG data may be stored in a viewer file. The viewer input also may be shared with a host. The processor may access content from the host, the Internet, or other sources to be included in the EPG based on analyzed viewer input. In addition, both a set top processor and a host may carry out the analysis of the viewer's input to generate a customized EPG.

Other features and advantages will be apparent from the description, the drawings, and the claims.

### DESCRIPTION OF DRAWINGS

FIG. 1 is a block diagram of an exemplary set top box system.

FIG. 2 is a block diagram of an exemplary set top box of the system of FIG. 1.

FIG. 3 is an exemplary display screen of an electronic program guide implemented by the system of FIG. 1.

FIGS. 4A and 4B are exemplary display screens of customized electronic program guides.

FIG. 5 is an exemplary procedure of selecting content to generate a customized EPG.

Like reference symbols in the various drawings indicate like elements

### DETAILED DESCRIPTION

System Overview

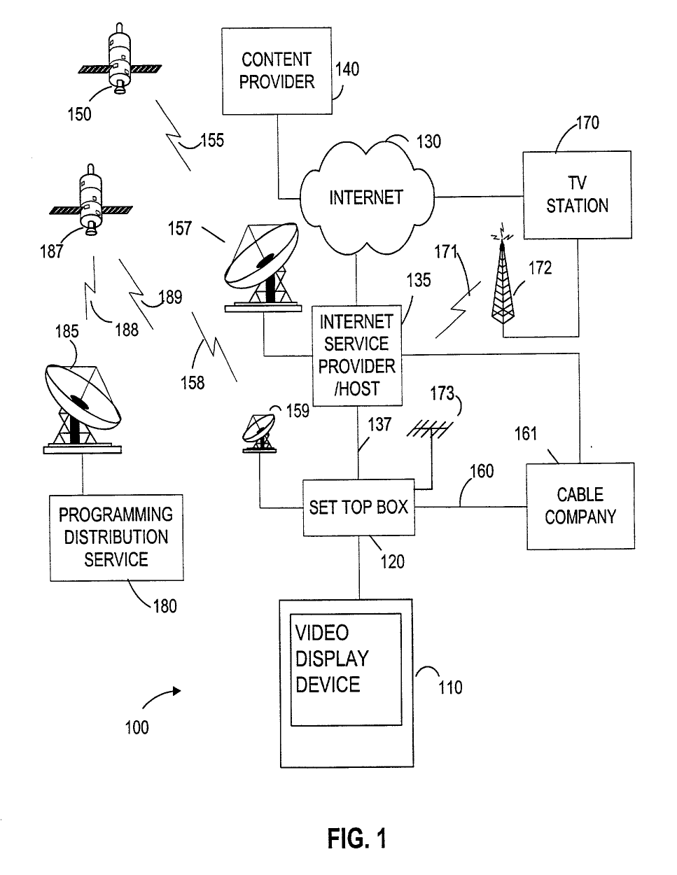

An exemplary set top box system 100, as shown in FIG. 1, includes a video display device 110 connected to set top box 120. The video display device 110 may be implemented using, for example, an analog TV, a digital TV, a high definition TV (HDTV), a video monitor, or another device capable of displaying analog and/or digital video signals.

The set top box 120 gathers and manages content for presentation on the video display device 110. The set top box 120 generally gathers and manages two primary types of content: web content and TV content. Web content includes, for example, digital information that is typically, but not exclusively, communicated over a communications network. Examples of web content include: a web page, an image file, an audio file, a video file, a data file, a program, an e-mail, an instant message, and a chat session. TV content may include digital and analog information intended for presentation on a video display device that generally corresponds to established standards, such as, for example, European Telecommunications Standards Institute (ETSI), Digital Video Broadcasting (DVB), Advanced Television Systems Committee (ATSC), or European Cable Communications Association (ECCA). Examples of TV content include a broadcast TV program, a satellite TV program, a cable TV program, an output of a video player/recorder device, such as, for example, a videocassette recorder (VCR), a laser disc player, and a digital videodisk (DVD) player, or output of a video camera.

The set top box 120 may use a variety of methods to gather web and TV content. The set top box 120 can be configured to receive web content from sources, such as an ultra high frequency (UHF) transmitter, a very high frequency (VHF) transmitter, a digital transmitter, a radio frequency (RF) transmitter, a satellite transmitter, a cable TV provider, and the Internet 130. For example, the set top box 120 can access web content over the Internet 130 through a connection to an Internet service provider (ISP) or host 135, such as America Online (AOLTM). The set top box 120 connects to the host 135 through a wired or wireless communications link 37 (e.g., a plain old telephone service (POTS), a digital subscriber line (DSL), or an integrated systems digital network (ISDN)) that typically is provided by a telecommunications company. Once connected to the host 135, the set top box 120 can gather web content from any number of content providers 140 connected to the Internet 130. Although shown as a single entity in FIG. 1, the host 135 may include one or more computers, processors, servers, and other equipment for performing various functions associated with the ISP.

The set top box 120 also can access web content from a satellite 150. The satellite 150 receives the web content from an uplink 155 provided by a transmitter 157 connected to, for example, the host 135. The web content is provided to the set top box 120 through a downlink 158 from the satellite 150 to a receiving dish 159. Similarly, the set top box 120 may receive web content through a cable communications link 160 connected to a cable company 161. Furthermore, web content may be inserted in the vertical blanking interval (VBI) of a TV signal (e.g., broadcast, cable, or satellite). Examples of using the VBI to send web content to the set top box 120 are described in U.S. application Ser. No. 09/584,347 filed Jun. 1, 2000, and titled “Online/Offline Triggers,” which is incorporated by reference.

The set top box 120 may receive TV content from a number of sources. For example, a TV station 170 may broadcast UHF and VHF TV signals 171 from a TV transmitter tower 172. An antenna 173 connected to the set top box 120 receives the TV signals 171. Likewise, a TV programming distribution service 180 (e.g., Direct TV™) can transmit TV content from a transmitter 185 to a satellite 187 for transmission to the receiving dish 159 connected to the set top box 120 using an uplink 188 and a downlink 189. TV content also may be provided directly to the set top box 120 by the cable company 161 using cable communications link 160.

Set Top Box

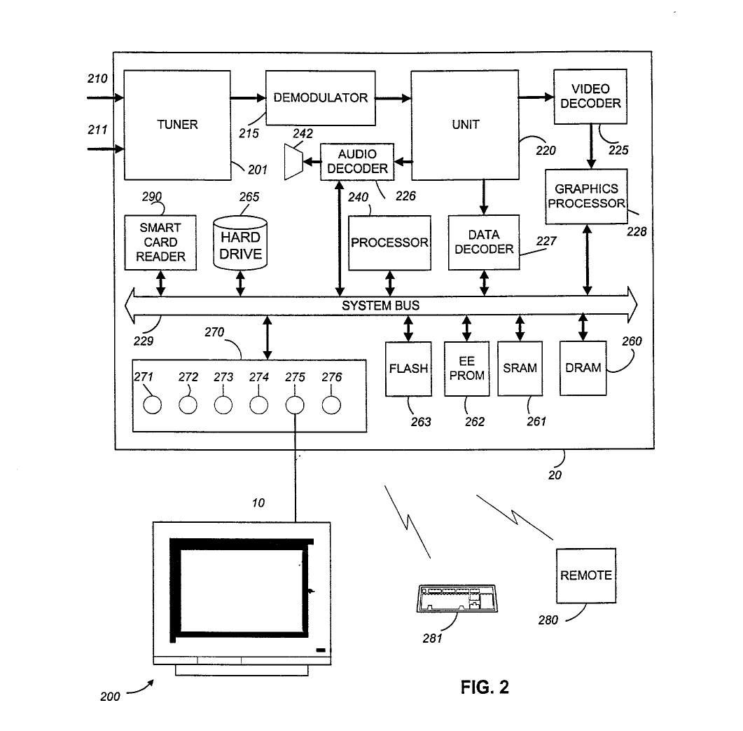

Referring to FIG. 2, an exemplary set top box system 200 includes a video display device 110 connected to a set top box 120. The set top box includes a tuner 201 that may receive quadrature amplitude modulation (QAM), orthogonal frequency division multiplexing (OFDM), and quadrature phase shift key (QPSK) digital TV signals 210. The digital TV signals 210 are received by the tuner 201 from various components, such as, for example, cable communications link 161 of system 100. Similarly, analog TV signals 211 are provided to the tuner 201 using various components, such as, for example, antenna 73 of system 100. The tuner 201 may be implemented using a broadcast in-band tuner, an out-of-band tuner, and a return path tuner. In addition, the TV tuner 201 may receive TV signals 210 or 211 from a video recorder/player device (e.g., a VCR, a DVD player, or a laser disc player) though a separate interface also may be provided for receiving these signals (as described in detail below). The tuner 201 generally isolates a physical channel from the received signal 210 or 211 and converts it to a baseband signal.

The analog baseband signal output from the tuner 201 is sent to a demodulator 215. The demodulator 215 samples an analog signal and converts it to a digital bit-stream (e.g., a Moving Pictures Experts Group (MPEG)-2 bit stream). The data may be organized in discrete units, such as, for example, data packets. The bit-stream may include video, audio, and other data. The bit-stream is checked for errors and is forwarded to a unit 220 that examines the packets in the bit-stream, selects particular packets, and forwards the packets to one or more of a video decoder 225, an audio decoder 226, or a data decoder 227.

The video decoder 225 transforms video packets into a sequence of pictures which may be displayed on the display device 110. The output from the video decoder 225 may be sent to an optional graphics processor 228 for enhanced TV and web content display. If a graphics processor is not included, the output of the video decoder 225 is sent directly to the system bus 229. The system bus 229 provides a communications path between the processor 240 and the various components of the set top box 120.

The audio decoder 226 decompresses an audio bit-stream received from the unit 220, and delivers the decompressed audio bit-stream to a speaker 242 or to the system bus 229.

The data decoder 227 is connected to the system bus 229 and decodes data packets received from the unit 220 or the system bus 229. The data decoder 227 uses the system bus 229 to deliver the decoded data packets for processing by a processor 240 or other set top box components.

The processor 240 operates according to any number of operating systems including those available from, for example, Power TV, VxWorks, pSOSystem, Microware, Microsoft, or Linux. The processor 240 provides a number of fimctions for the set top box 120. The processor 240 initializes the set-top box hardware, monitors and manages hardware interrupts, and fetches data and instructions from memory. The processor 240 also processes a range of web and TV content data. In addition, the processor 240 may execute various programs and applications, such as, for example, a browser, stored in the memory or storage of the set top box 120.

The set top box 120 may include a number of memories. For example, a random access memory (RAM) may be used as a temporary storage area for data flowing between the processor 240 and set top hardware. Dynamic RAM (DRAM) 260 and static RAM (SRAM) 261 are examples of memory that may be used. The DRAM 260 typically is used for interactive applications, while the SRAM 261 generally is used to support time sensitive applications, such as MPEG processing.

Non-volatile memory, such as an electrically erasable programming read only memory (EEPROM) 262 and a flash memory 263, also may be provided. The EEPROM 262 generally is used to store control programs and boot-up information for the processor 240. The flash memory 263 may be used to store programs and customer specific information. In addition, the flash memory 263 may be used to store data downloaded from the host 135 to provide additional functionality to the set top box 120 and to store temporary data that are continually updated.

The set top box 120 also may include one or more large-scale memory devices, such as a hard drive 265. The hard drive 265 may be used to store TV and web content, such as, for example, personal documents, favorite Internet sites, email, recorded TV content, data files, audio files, video files, programs, and other data.

The set top box 120 may include a number of input/output (I/O) interfaces 270 including: a modem 271, a high-speed multimedia interface 272, a serial interface 273, a common interface 274, a TV and VCR interface 275, and a wireless interface 276 to wireless devices, such as a remote control 280 and a wireless keyboard 281. The set top box also may include a smart card reader 290. The I/O interfaces provide a communications path between external devices and the system bus 229 to facilitate the exchange of data with the set top box 120. The set top box 120 may include one or more of these interfaces.

The modem 271 facilitates two-way interactivity between the set top box 120 and the host 135 or a service provider (e.g., cable company 61). Once activated, the modem 271 can send a request to a web server on the Internet 130, download a file, send an email, and facilitate a two-way interactive service, such as home shopping or video-on-demand.

The high-speed multimedia interface 272 allows the set top box 120 to communicate in real time with other devices, such as a camcorder, a DVD player, a laser disk player, a CD player, and a digital camera. The high-speed interface 272 may be implemented using various hardware devices, such as, for example, an IEEE 1284 parallel port, a universal serial bus, IEEE 1394 interface (i.e., Firewire) and a 10/100 Base-T (i.e., Ethernet) device.

The serial interface 273, for example, an RS-232 interface, provides a serial communications interface that allows the set top box 120 to exchange data with other devices, such as, for example, a printer, a computer, a personal data assistant (PDA), or an external storage device.

The common interface 274 may provide a standardized interface to connect the set top box 120 with a separate hardware module, such as a personal computer memory card international association (PCMCIA) interface.

The TV and VCR interface 275 allows the set top box 120 to communicate with the display device 110 and a video recorder/player. The wireless remote control interface 276 receives control signals from a viewer interface device, such as, for example, a remote control device 280 and a wireless keyboard device 281. The control signals are interpreted by processor 240 to activate and control functions of the set top box 120 and the display device 110. The viewer interface devices may communicate with the remote control interface 276 using RF signals, infrared signals, or otherwise.

Smart card reader 290 may read a smart card that contains, for example, identification information for authorizing access to the host 135, accessing the programming distribution service 80, or conducting an e-commerce transaction.

The set top box 120 constructs or formats a display for presentation on a screen of the display device 110. The display may be constructed from web content, TV content, or a combination of both web and TV content. A browser application (e.g., Liberate's TV navigator) being run by the set top processor 240 creates the display from outputs of the memories (e.g., 260, 261, and 262), the hard disk 265, the I/0 interfaces 270, and/or the decoders (e.g., 225, 226, and 227). The browser can support a number of computing standards including, for example, hypertext markup language (HTML), Java, JavaScript, and hypertext transfer protocol (HTTP).

The browser integrates web and TV content by processing, for example, a window tag. A window tag is an HTML-like tag (e.g., <IMG SRC=“TV” x=0 y=0>) that instructs the browser to place TV content received by the set top box 120 on the screen of the display device 110 at specified coordinates. By modifying a received web page to include a window tag, the browser can display the TV content in conjunction with web content in windows for each type of content. Any number of content windows may be displayed on a screen at one time. In addition, the windows may be separate or appear to overlap each other. Web content also may be assigned HTML-like tags indicating the arrangement of the web content on the screen. The screen of the display device 110 can be modified to insert user controls, resize the TV image, and provide interactive links by altering instructions of the web content displayed by the browser.

In addition, the set top box 120 may present content that is overlaid with user interface controls or menus. The controls and menus correspond to functions (e.g., tuning channels) performed by the set top box 120. Interactive controls and display windows also may be overlaid on the TV content or web content on the screen of the display device 110. One example of the combination of interactive displays overlaying TV content is described in U.S. application Ser. No. 09/365,734 filed Aug. 3, 1999, and titled “Providing Interactive Links in TV Programming,” which is incorporated by reference.

Electronic Program Guide

An EPG organizes TV content based on various criteria, such as, for example, a date, a time, and a channel. The EPG may include any number of formats to convey information to a viewer. The EPG is typically activated using a viewer input device (e.g., remote control 280 or wireless keyboard 281). The processor 240 receives the command from the viewer input device to display the EPG and creates the EPG from data received from the host 135 for display on display device 110.

The EPG may include both web and TV content. A browser run by the processor 240 determines how the web and TV content are presented to the viewer on a display screen (e.g., as described in the preceding section). The EPG display screen may be divided into a number of sections including, for example, a TV content section, a web content section, a programming guide section, an advertisement section, a description of channels and programming section, a controls section, a menu section, and an interactive link section.

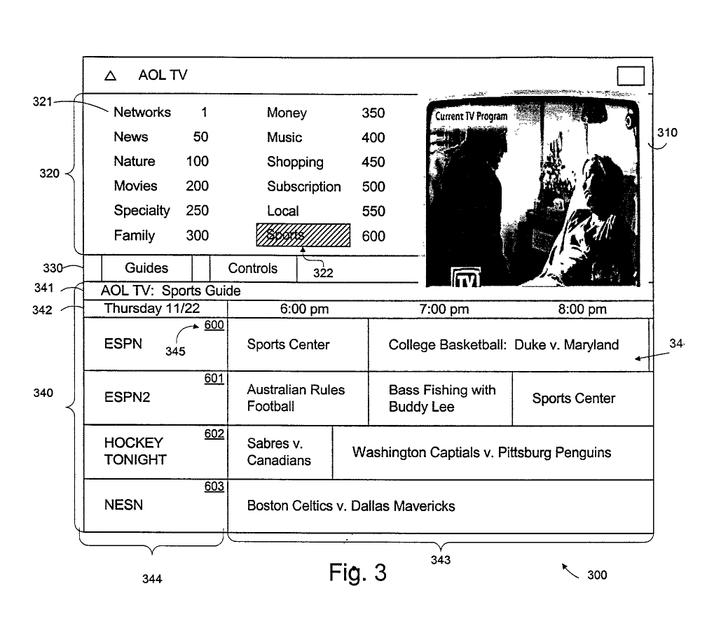

Referring to FIG. 3, an exemplary display of an EPG 300 may include a number of sections, such as, for example, a display section 310, a category section 320, an interface area 330, and a program guide 340. The display section 310 displays TV content, such as, for example, the programming content of a channel being presented on the display device 110. The category section 320 includes a list of categories 321 that provide a reference to content grouped by subject matter, such as, for example, network TV, news, nature, movies, specialty, family, money, music, shopping, local TV, and sports. A viewer may select a category 322, such as, for example, sports, using a viewer input device. In response to selecting a category, the set top box 120 may display a list of channels corresponding to the selected category 322 in a program guide 340.

The program guide 340 may include, for example, a title bar 341 that displays the selected category 322 (e.g., AOL TV Sports Guide) corresponding to the content of the channels in the program guide 340. The program guide 340 also may include another bar 342 that displays the date and the time corresponding to the content displayed in the program window 343 (e.g., Thursday November 22^{nd} for the hours 6:00 P.M. to 8:00 P.M.).

The program guide 340 may include a list 344 of channels 345 (e.g., ESPN, ESPN2, Hockey Tonight, and NESN) associated with the selected category 322. If there are more channels 345 in a category 321 than may be simultaneously displayed in the program guide 340 of EPG 300, a viewer may scroll through the channels 345 using a viewer input device. Using the viewer input device, a channel may be highlighted to indicate a channel selection. Using the viewer input device, the selection may be entered, and the processor 240 may tune to the selected channel.

The program window 343 also includes a number of program bars 346. The program bars 346 describe the content that is available on a corresponding channel during an indicated time slot (e.g., Sports Center at 6:00 P.M. and college basketball from 6:30 P.M. to 8:30 P.M.). The viewer may select a program bar 346 by highlighting the program bar 346 and entering the selection using the viewer input device. In response, a short description of the programming content of the selected program bar 346 may be displayed, for example, in the program bar or as overlaying a portion of the EPG 300.

Modified Electronic Programming Guide

When a viewer starts using the set top box 120, an EPG, such as the exemplary EPG 300 may be displayed. Initially, an EPG is not customized for the viewer and may include generic information based on demographic data previously collected, for example, by the host 135 when a viewer acquires the host's service. However, after the viewer has interacted with the set top box 120, the EPG may be customized specifically for the viewer based on the viewer's actions.

A viewer interacts with the set top box using a viewer input device, such as, for example, a wired or wireless remote control, a keypad, and a wired or wireless keyboard. The viewer controls functions of the set top box by inputting commands from the viewer input device. For example, the viewer may command the set top box 120 to change channels, select programming, view web pages, read email, purchase items, rate shows, set reminders, record programming, and answer polls. In particular, the viewer inputs commands to use the EPG, such as, for example, selecting categories, looking up information about programming, using EPG controls, and selecting programming content. The viewer's input commands may be saved in a memory or storage of the set top box 120 in a viewer file, in an input command cache, or another location.

The contents of the memory or viewer file may be transmitted periodically to the host 135. A viewer's enters commands also may be sent directly to the host 135 when the set top box 120 is online (e.g., connected to the host 135 by communications link 137). Once received, the host 135 analyzes the commands to determine, for example, viewing patterns, habits, and preferences of the viewer. More specifically, viewer input commands may be used to determine, for example, indications of the viewer's favorite programming, favorite guides, favorite categories of programming, type of web content viewed, and most frequently used functions of the EPG. Furthermore, other types of data analysis, such as, for example, viewer demographic analysis, may be combined with the viewer command input analysis to provide additional customization. The analysis may be performed by the host 135 or by a partner company, such as a consulting firm. The analysis may be manual, automated, or a combination of both.

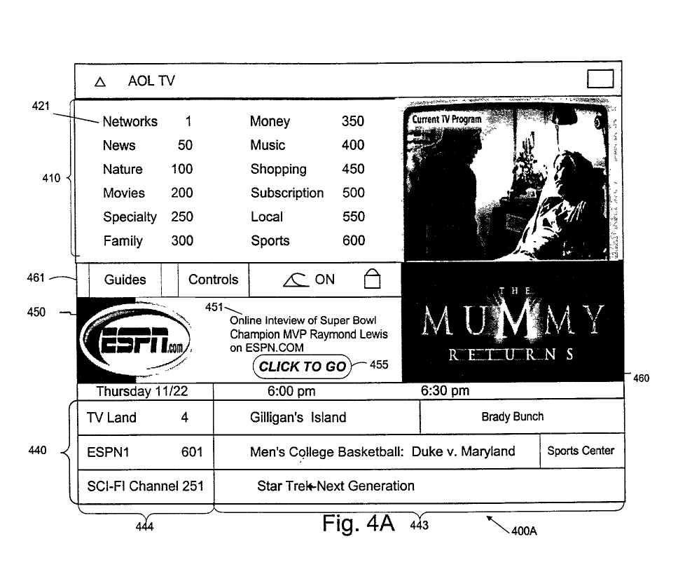

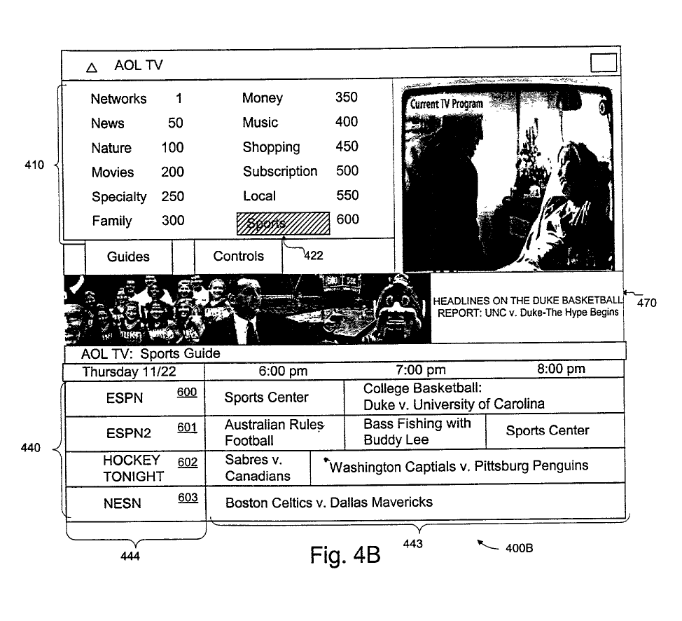

After using the set top box 120 for a predetermined period of time, the host 135 may accumulate data on the viewer's viewing habits and interests as is illustrated in the following examples. For example, to generate the exemplary customized EPGs 400A and 400B, shown in FIGS. 4A and 4B, the host 135 periodically accessed a viewer's file and determined that the three channels viewed the most during a predetermined period are TV land, ESPN, and the Sci-Fi channel. The host 135 also determined that the set top box 120 was tuned to ten out of sixteen Baltimore Ravens football games during the football season. In addition, when the display device was tuned to Ravens football games, the host 135 determined that the set top box 120 had been used to tune to web sites about the Ravens football team and its players. The host 135 also determined that the viewer reviewed a number of movie listings for local theatres and watched a significant amount of science fiction/fantasy TV programming content.

The viewer's data is processed by the host 135 to provide customized EPG data that are tailored to the viewer. The host sends EPG data to the set top box 120 for display to the viewer. When the viewer activates the EPG function, the set top box 120 creates a customized EPG 400A using the EPG data. The EPG 400A includes, for example, a programming guide section 440 displaying a channel list 444 for the programming 443 of the viewer's three most popular channels (e.g., TV-Land, The Sci-Fi Channel, and ESPN). When preparing the EPG data for download to set top box 120, the host 135 determines that web content of potential interest to the viewer is available and includes interactive link data (e.g., a link to an interview with the Ravens' Super Bowl MVP Raymond Lewis). The interactive link data is used by the set top processor 240 to form an information box 450 that includes a logo of the channel associated with the link, information 451 about the link, and an interactive button 455 that allows the viewer to navigate to the web content described in the box 450. Although a single link is shown in EPG 400A, one or more links may be included.

The processor 240 and the host 135 may store the type of display device 110 connected to the set top box 120. As a result, the size and format of the EPG can be customized specifically for the type of display device 110. For example, EPGs for large screen TVs may be formatted to include more content, such as multiple links of interest to the user.

When the host 135 or the processor 240 determines that there are more links of interest than can be displayed on the display device 110 at one time, the host 135 or the processor 240 may display only those links determined to be of the most interest to viewer based on the viewer's interaction with the set top box 120. The window 450 displaying the links may rotate the display of the links to show each individual link for a predetermined period of time before switching to a display of the next link, or the viewer may scroll through links using the viewer input device. In this way, EPGs having space to display a single link at a time may display multiple links of interest to the viewer.

The EPG 400A also contains an advertising section 460. In this example, the host 135 determined that the viewer is likely to be interested in the newly released movie “The Mummy Returns” based on the viewer's demographics, the viewer's selected programming, and the viewer's use of movie guides. As a result, the host includes EPG data for an advertisement for the movie that is displayed in the advertising section 460. The advertisement may be interactive in that it allows the viewer to navigate to a web site associated with the advertisement. For example, a trailer or link to a site containing reviews about the movie “The Mummy Returns” may be accessed when the viewer selects the advertisement box using a viewer input device. The advertisements also may be commercials. Multiple advertisements may be displayed and the number of advertisements may be customized based on the type of display device 110 connected to the set top box 120. In addition, the display of advertisements may be rotated to display a number of advertisements.

The customized EPG 400A may be formatted by the host 135 and sent to the set top box 120 for immediate display. However, data used to form the EPG 400A may be downloaded and stored on the set top box 120 in a memory, such as, for example, on the hard disk drive 265 or in the flash memory 263. Data for the entire EPG may be stored in a memory or data for portions of the EPG may be stored. When the EPG function is activated, the processor 240 may request EPG data from the host 135, tune to a channel presenting an EPG, or access the memory to retrieve EPG data and create the EPG for display.

If the processor 240 requests EPG data from the host 135, the EPG data received from the host 135 may be processed to form the EPG for display. However, the host 135 may supply default EPG data to the processor 240 that may be customized by the processor 240 by accessing customized EPG data stored in a memory or viewer file. For example, the advertisement for the Mummy Returns in EGP 400A may be downloaded to the set top box 120 and stored on the set top's hard drive 265 or flash memory 263. When EPG data is processed by the set top box 120, the processor 240 may access an advertisement file and insert the advertisement in an advertisement section 460 of the EPG provided by the host 135.

The processor 240 also may form the entire EPG from EPG data stored by the set top box 120. This technique allows EPG data to trickle down to the set top box 120 as the EPG data is updated. In addition, the EPG may be customized even if the set top box 120 is currently offline or not connected to the host 135.

An EPG commonly includes a viewer interface 461 having a number of viewer interactive controls. The controls may include, for example, program recording functions, EPG display functions, and parental or content control functions. The controls may be accessed by selecting a control portion of the EPG with the viewer input device. In response to the selection, a window, such as, for example, a menu of controls, may be displayed on the screen of the display device 110. The viewer may interact with the menu to select and operate the controls associated with the interface. The host 135 may monitor the viewer's inputs to determine which controls are being used by the viewer most frequently and when. The host 135 may customize the control panel to include the controls most commonly used, for example, in a menu or on the EPG.

The EPG also may be customized based on the viewer's selections, such as, for example, the selection of a category. As shown in FIG. 4A, the EPG 400A includes a guide section 410 that lists a number of channel categories 421. When a viewer selects the category sports 422, a new EPG 400B, shown in FIG. 4B, which includes a channel category section for sport channels, may be displayed. In this case, one of the viewer's favorite channels (e.g., ESPN) is located in the category 422 and is displayed at the top of the channel list 444. The host 135 also includes EPG data for a programming description and an interactive link 470 for upcoming programming on the viewer's favorite channel.

The EPG also may be customized to include one or more mini-guides. Mini-guides may include programming related to a particular topic regardless of the channel or the source. For example, a “John Wayne” mini-guide may include listings and links to John Wayne Movies or a “Star Trek” mini-guide may include listing of all Star Trek related programming. The mini-guides may be display in any portion of the EPG or as a pull-down menu or sub-display. The mini-guides that are displayed may be generated based on the viewer's interaction with the set top box 120. For example, if it is determined that the viewer watches a certain number of westerns, a “Westerns” mini-guide may be generated and displayed in the EPG.

Customization of the EPG also may be performed by the processor 240 without aid of the host 135. Customization software may be stored one of the set top box's storage devices (e.g., hard drive 265). The processor 240 may monitor and analyze the viewer's interaction with the EPG, and based on the viewer's interaction customize the appearance of the EPG in any of the ways described above. For example, the processor 240 may customize tool bar controls, display the user's favorite channels, establishing mini-guides of topics of interest to the viewer, search the Internet 130 for content determined to be of interest to the viewer, and provide customized advertising. The processor 240 also may search the Internet 130 when online to pull content to the set top box 120 to be used in the customization of the EPG. Viewer preferences also may be stored in a viewer file which may be shared with the host 135. The customization software used by the processor 240 may be updated from time to time through downloaded programming or using one of the interfaces of the set top box 120.

Customization also may be provided to the viewer using both the processor 240 and the host 135. The processor 240 may customize the EPG based on the viewer's interaction with the EPG as described above. However, viewer data also may be sent to the host 135 for analysis. Based on this analysis, customized EGP data may be sent from the host 135 to the set top box 120 and incorporated in the customized EPG by the processor 240. The customized EPG data sent from the host 135 may be prepackaged and directly inserted into dedicated portions of the EPG, the customized EPG data may be used by the processor 240 to create an entire EPG for display, or the processor may process the EPG data to determine how the data should be incorporated for display.

Modifying Electronic Programming Guide Content

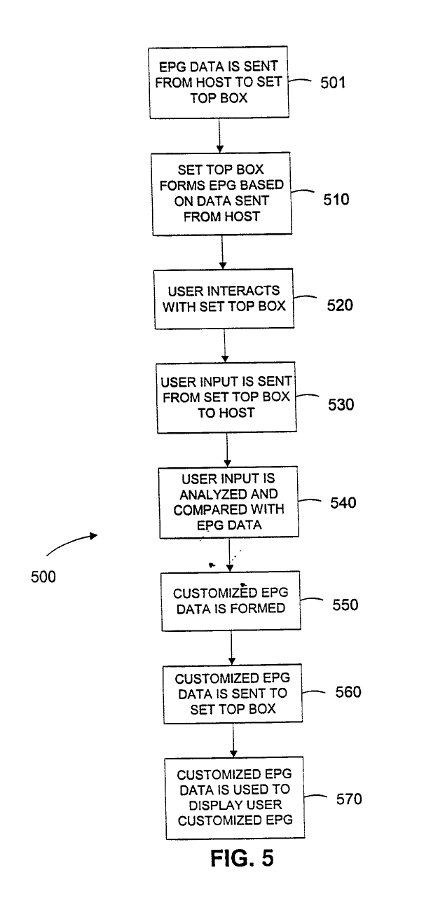

Referring to FIG. 5 the content of an EPG may be selected or modified according to the exemplary procedure 500. When a viewer first interacts with an EPG, the EPG is not based on customized viewer data or is based on viewer demographic data that was obtained by the host 135 when the viewer acquired services from the host 135.

EPG data are transmitted from a host 135, such as, for example, a TV programming broadcaster or ISP (step 501) to the viewer's set top box 120. The EPG data may be transmitted using any of a number of different mediums. For example, EPG data may be transmitted using the VBI of a broadcast TV signal, a satellite communications link (e.g., 150, 155, 157, and 158), or a wired or wireless telecommunications link 37.

The EPG data is received by the set top box 120 (step 510), and may be stored in a memory or storage, such as, for example, the memories and storage devices described with respect to FIG. 2. The set top box 120 processes the EPG data using a browser run by processor 240 to form the EPG display on the screen of the display device 110. The viewer may activate the EPG for display using a viewer input device.

As the viewer interacts with the set top box 120 and the EPG using a viewer input device, the viewer provides commands to the set top box 120 to perform any number of functions (step 520). The viewer's input commands may be saved in a memory or storage of the set top box 120, for example, in a viewer file.

The contents of the memory or viewer file may be transmitted periodically to the host 135 or the viewer's input commands may be sent directly to the host 135 when the set top box 120 is online (e.g., connected to the host 135 by communications link 37) (step 530).

After the viewer's input commands are sent to the host 135, the commands are analyzed to determine, for example, viewing patterns, habits, and preferences of the viewer (step 540).

Based on the viewer's analyzed actions and input, EPG content is selected to form a customized EPG for the viewer of the set top box 120 (step 550). Customized EPG data are used to create a customized EPG that is tailored to a specific viewer. For example, the EPG may include a listing for the viewer's favorite shows, their times, and their channels. The EPG also may include a summary of the viewer's favorite show and/or other shows and movies that may appeal to the viewer. One or more web pages related to a channel's content may be displayed in addition to chat rooms with topics of interest to the viewer, such as, for example, the viewer's favorite shows. Links to content of interest to the viewer also may be displayed. The appearance and arrangement of sections of the display may be customized based on the viewer's use of the EPG. An advertisement banner or area may be used to show commercials and advertisements that are directed to the viewer's interests.

The customized EPG data are sent to the set top box 120 (step 560). The data are processed by the set top box 120 to form an EPG for display on the display device 110 (step 570). The customized EPG data also may be stored in the set top box 120. The customized EPG data may be accesses by the processor 240 to form the customize EPG at an appropriate time. In addition, the customized EPG data may be used to supplement basic EPG data supplied by the host 135, to create a customized EPG. For example, the EPG may include an advertisement section. More specifically, a file in the memory of the set top device may store advertisements of specific interest to the viewer that are downloaded from the host 135. The processor 240 may access the file to display the advertisements in the advertisement section of the EPG when appropriate. For example, the processor 240 may show a food commercial at meal times. By downloading and storing EPG data in a file, the EPG may be customized even when the set top box 120 is offline.

The procedure of FIG. 5 is an iterative process. As the viewer continues to interact with the EPG, the EPG continues to evolve with the viewer's changing habits by sending viewer commands to the host 135 for analysis and receiving in return EPG data that are customized for the viewer. As a result, the EPG may be seamlessly customized for a specific viewer and may be able to provide the viewer with unique interactive opportunities.

If more than one viewer uses the set top box, a viewer may be provided with an individualized viewer input device that identifies the viewer to the set top box 120, for example, by sending a viewer identification code when operated. As a result, a separate file of viewer commands may be stored and analyzed for each viewer having an individual viewer input device. Individualized EPG data then may be stored in the set top box for each viewer. When using the individualized viewer input device, the set top box displays customized EPG data corresponding to the viewer input device.

As described in the preceding sections, the steps 530, 540, 550, and 560 may be entirely implemented by the processor 240 or in combination by the processor 240 and the host 135.

Using the procedure of FIG. 5, a viewer's file may be continually updated. As a result, the format of an EPG displayed for a viewer is continually updated and customized according to any changes in the viewer's habits and interests. In addition, advertising is more effective because the products and services that are displayed are tailored specifically for the viewer. The EPG also becomes more useful to the viewer because it contains the information and links that are the most helpful to the viewer in manner or format that is preferred by the viewer. Moreover, as the EPG will become more useful, the viewer will more frequently use the EPG and the EPG becomes a more effective advertisement medium.

A number of implementations have been described. Nevertheless, it will be understood that various modifications may be made. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A set top box comprising:
a display interface for outputting display data;
an input for receiving viewer commands;
an interface for sending the viewer commands to be analyzed;
an interface for receiving customized electronic program guide (EPG) data; and
a processor for creating a customized EPG display from the received customized EPG data for output to the display interface, wherein the received customized EPG data is based on the analyzed viewer commands.

2. The set top box of claim 1 further comprising a memory for storing viewer commands.

3. The set top box of claim 2 wherein the stored viewer commands are periodically accessed by the processor and sent to a host for analysis.

4. The set top box of claim 1 wherein the processor runs a browser application and the browser application creates the customized EPG.

5. The set top box of claim 1 further comprising a memory for storing customized EPG data wherein the processor uses the stored customized EPG data to create the customized EPG for display.

6. The set top box of claim 5 wherein the processor receives default EPG data for creating an EPG, accesses the stored customized EPG data from the memory, and creates the customized EPG from the received default EPG data and the stored customized EPG data.

7. The set top box of claim 5 wherein the processor creates the customized EPG from the stored customized EPG data when the set top box is offline.

8. The set top box of claim 1 wherein the customized EPG data include a commercial or advertising.

9. The set top box of claim 1 wherein the customized EPG data include one or more mini-guides.

10. The set top box of claim 1 wherein processor determines the identity of a viewer from the input viewer command and creates the customized EPG based on the determined viewer identity.

11. The set top box of claim 1 further comprising a memory wherein the processor determines the identity of a viewer based on an input viewer command and stores the input viewer command in a viewer file that is associated with the determined viewer identity.

12. A method for display a customized electronic program guide (EPG) comprising:
receiving viewer commands;
sending the viewer commands to be analyzed;
receiving customized EPG data based on the analyzed commands;
creating a customized EPG display from the received customized EPG data; and
displaying the customized EPG.

13. The method of claim 12 further comprising storing the viewer commands.

14. The method of claim 13 further comprising periodically accessing the stored viewer commands and sending the stored viewer commands to be analyzed.

15. The method of claim 12 further comprising storing the customized EPG data and creating the customized EPG from the stored customized EPG data.

16. The method of claim 12 further comprising using a browser application running on a processor to create the customized EPG.

17. The method of claim 15 further comprising receiving default EPG data for creating an EPG and accessing the stored customized EPG data to create a customized EPG from the received default EPG data and the stored customized EPG data.

18. The method of claim 15 wherein the customized EPG data include a commercial or advertising.

19. The method of claim 12 further comprising determining the identity of a viewer from the input viewer commands and creating the customized EPG based on the determined viewer identity.

20. The method of claim 12 further comprising determining the identity of the viewer and storing the viewer commands in a viewer file that is associated with the determined viewer identity.

21. The method of claim 12 wherein the customized EPG data include one or more mini-guides.

22. A method for creating an electronic program guide (EPG) comprising:
receiving a viewer's input to a set top box;
analyzing the viewer's input; and
customizing content for the EPG based on the viewer's analyzed input.

23. The method of claim 22 wherein receiving the viewer's input include s receiving signals associated with a viewer input device.

24. The method of claim 22 further comprising periodically receiving an additional viewer's input data, analyzing the additional viewer's input, and customizing the content for the EPG based on the additional viewer's input.

25. The method of claim 22 comprising sending customized EPG data to the viewer for display.

26. The method of claim 25 further comprising sending customized EPG data associated with a section of the customized EPG.

27. The method of claim 22 wherein the receiving of the viewer's input includes receiving data indicating at least one of a change of channels, a guide selection, a category selection, a programming selection, a recorded program, an indication of viewed web content, a purchase or transaction, and a rating of a show.

28. The method of claim 22 wherein the customized EPG data include one or more mini-guides.

29. A host comprising:
an interface for receiving a viewer's set top box input;
a processor for analyzing the viewer's input; and
a processor for determining customized data for an electronic program guide (EPG) based on the viewer's analyzed input.

30. The host of claim 29 wherein the viewer's input includes a signal from a viewer input device.

31. The host of claim 29 wherein the host periodically receives an additional viewer's input data that is analyzed and used to determine customized content for the EPG.

32. The host of claim 29 comprising an interface for sending customized EPG data to the viewer for display.

33. The host of claim 29 further comprising an interface for sending customized EPG data associated with a section of the customized EPG.

34. The host of claim 29 wherein the viewer's input includes data indicating at least one of a change of channels, a guide selection, a category selection, a programming selection, a recorded program, an indication of viewed web content, a purchase or transaction, and a rating of a show.

35. The host of claim 29 wherein the customized EPG data include one or more mini-guides.

36. A set top box comprising:
a display interface for outputting display data;
an input for receiving viewer commands; and
a processor for analyzing the viewer commands and creating a customized EPG display based on the analyzed viewer commands.

37. The set top box of claim 36 further comprising a memory for storing viewer commands.

38. The set top box of claim 37 further comprising an interface for sending the viewer commands to be analyzed, wherein the stored viewer commands are periodically accessed by the processor and sent to a host for analysis.

39. The set top box of claim 36 wherein the processor runs a browser application and the browser application creates the customized EPG.

40. The set top box of claim 36 further comprising a memory for storing customized EPG data wherein the processor uses the stored customized EPG data to create the customized EPG for display.

41. The set top box of claim 36 further comprising an interface for receiving customized electronic program guide (EPG) data based on the analyzed viewer command; wherein the processor creates an EPG using the customized EPG data.

42. The set top box of claim 36 further comprising an interface to access the Internet wherein the processor gathers content from the Internet based on the analyzed viewer commands to be included in the customized EPG.

43. The set top box of claim 36 wherein the EPG includes a commercial or advertising.

44. The set top box of claim 36 wherein processor determines the identity of a viewer from the input viewer command and creates the customized EPG based on the determined viewer identity.

45. The set top box of claim 36 further comprising a memory wherein the processor determines the identity of a viewer based on an input viewer command and stores the input viewer command in a viewer file that is associated with the determined viewer identity.

46. The set top box of claim 38 wherein the customized EPG is based on viewer commands analyzed by the processor and by the host.

47. The set top box of claim 36 wherein the customized EPG data include one or more mini-guides.
